(19) United States
(12) Patent Application Publication
(10) Pub. No.: US 2007/0164978 A1
(43) Pub. Date: Jul. 19, 2007

(54) Method and system or driving a display apparatus

(75) Inventors: Shu-Ming Chang, Hsinhua (TW); Yu-Pei Huang, Hsinhua (TW); Shen-Yao Liang, Hsinhua (TW); Shwang-Shi Bai, Hsinhua (TW)

Correspondence Address: THE WEBB LAW FIRM, P.C., 700 KOPPERS BUILDING, 436 SEVENTH AVENUE, PITTSBURGH, PA, 15219, US

(73) Assignee: HIMAX TECHNOLOGIES, INC., Hsinhua (TW)

(21) Appl. No.: 11/492,580

(22) Filed: Jul. 25, 2006

(30) Foreign Application Priority Data
Jan. 16, 2006 (TW) 95101639

(51) Int. Cl. G09G 3/36

(52) U.S. Cl. 345/102

(57) ABSTRACT

The display apparatus has several display blocks. The display blocks are driven in a first sequence during a first frame period. The display blocks are driven in a second sequence during a second frame period immediately following the first frame period. The display block driven last in the first sequence is driven first in the second sequence, and an order of each of the other display blocks in the second sequence is higher than that in the first sequence by one.

### RELATED APPLICATIONS

The present application is based on, and claims priority from, Taiwan Application Serial Number 95101639, filed Jan. 16, 2006, the disclosure of which is hereby incorporated by reference herein in its entirety.

### BACKGROUND

1. Field of Invention The present invention relates to an active display apparatus. More particularly, the present invention relates to a method and system for driving a display apparatus.

2. Description of Related Art

Progress in the development of flat panel displays (FPD) has led to a shift from conventional cathode-ray tube (CRT) displays to liquid crystal displays (LCD) because they occupy less volume, are lighter, emit lower radiation and have lower power consumption. Nowadays, LCD panels are used commercially in consumer products, such as personal digital assistants (PDA), mobile phones, cameras, laptops and televisions.

FIG. 1 shows a conventional liquid crystal display (LCD) 100. The LCD 100 comprises a pixel array 102 used to display an image and a backlight module 108. A scan backlight control mode is generally used to improve the quality of dynamic images. In the scan-backlight control mode, the whole pixel array 102 is divided into several display blocks, that is, display blocks 102a-102d. Similarly, the whole backlight module 108 is also divided into several backlight blocks 108a-108d that respectively correspond to the display blocks 102a-102d. The display blocks 102a-102d are respectively scanned by gate driver circuits 106a-106d, and are then driven by a data driver circuit 104. The backlight blocks 108a-108d are respectively turned on and off by backlight driver groups 110a-110d.

The data driver circuit 104, the gate driver groups 106a-106d and the backlight driver groups 110a-110d are controlled by a driver control circuit 112. In the scan-backlight control mode, the driver control circuit 112 controls the gate driver groups 106a-106d and the data driver circuit 104 to respectively scan and drive the display blocks 102a-102d in a fixed sequence from the display block 102a to the display block 102d. At the same time, the driver control circuit 112 controls the backlight driver groups 110a-110d to turn on the backlight blocks 108a-108d in the sequence used to drive the display blocks 102a-102d for displaying a complete frame of image.

The response time of the liquid crystal in LCD displays is significant so that a charging period during which the voltage across the liquid crystal raises to a desired level can not be ignored. When the backlight block corresponding to the display block is turned on within the charging period, an undesired image is displayed. Therefore, the backlight block should be turned on only after the charging period of the display block is finished.

According to the foregoing principle, FIG. 2 shows the turning-on sequence of each backlight block for several continuous frames. During the clock cycles 1-4, the display blocks 102a-102d are driven in a fixed sequence. The clock cycles 1-4, 5-8 and 9-12 can be seen as three frame periods. The charging period of liquid crystal of the display block is composed of, for example, two clock cycles. During the first frame period (clock cycles 1-4), although the display block 102a is driven in the clock cycle 1, the backlight block 108a corresponding to the display block 102a is not turned on until the clock cycle 3. During the second frame period (clock cycles 5-8), the backlight block 108a is not turned on until the clock cycle 7 which is a counterpart of the clock cycle 3. Similarly, the backlight block 108b corresponding the display block 102b is turned on in clock cycles 4 and 5. The backlight block 108c corresponding the display block 102c is turned on in the clock cycles 5 and 6. The backlight block 108d corresponding the display block 102d is turned on in the clock cycles 6 and 7.

Consequently, each of the backlight blocks 108a -108d is only turned on for half of one frame period so that the brightness resulting from the previously described backlight control mode is half of that resulting from a backlight system constantly turning on the backlight.

In general, the problem of brightness loss can be alleviated by increasing the brightness of the backlight module, but it will increase power consumption and degrade the life time of the backlight module.

### SUMMARY

It is therefore an objective of the present invention to provide a method and system for driving a display.

It is another objective of the present invention to provide a method and system for driving the display blocks in different sequences for different frames.

It is still another objective of the present invention to provide a method and system for enhancing the brightness of the image displayed on a display apparatus.

It is still another objective of the present invention to provide a method and system for enhancing the quality of a dynamic image displayed on a display apparatus.

According to one preferred embodiment, a method for driving a display apparatus having a plurality of display blocks is provided. The display blocks are driven in a first sequence during a first frame period, and the display blocks are driven in a second sequence during a second frame period immediately following the first frame period. The display block driven last in the first sequence is driven first in the second sequence, and an order of each of the other display blocks in the second sequence is higher than that in the first sequence by one.

According to another preferred embodiment, a method for controlling a backlight module having at least one backlight block is provided. The backlight block is turned on during a first turning-on period within a first frame period. The backlight block is turned on during a second turning-on period within a second frame period immediately following the first frame period. The first turning-on period within the first frame period is one other than a counterpart of the second turning-on period within the second frame period.

According to another preferred embodiment, a system for driving a display apparatus having a plurality of display blocks is provided. The system comprises a sequence generating module, a gate driving control module and a data driving control module. The sequence generating module determines a first and second sequence. The gate driving control module controls a plurality of gate driver groups of the display apparatus to scan the display blocks according to the first and second sequence. The data driving control module controls a data driver circuit of the display apparatus to drive the display blocks scanned by the gate driver groups. The display blocks are driven in the first sequence during a first frame period and driven in the second sequence during a second frame period immediately following the first frame period, the display block driven last in the first sequence is driven first in the second sequence, and an order of each of the other display blocks in the second sequence is higher than that in the first sequence by one.

According to another preferred embodiment, a display apparatus comprises a pixel array, a plurality of gate driver groups, a data driver circuit and a control circuit. The pixel array comprises a plurality of display blocks. The gate driver groups scan the display blocks. The data driver circuit drives the display blocks scanned by the gate driver groups.

The control circuit comprises a sequence generating module, a gate driving control module and a data driving control module. The sequence generating module outputs a first and second sequence. The gate driving control module controls a plurality of gate driver groups of the display apparatus to scan the display blocks according to the first and second sequence. The data driving control module used to control a data driver circuit to drive the display blocks scanned by the gate driver groups. The display blocks are driven in the first sequence during a first frame period and driven in the second sequence during a second frame period immediately following the first frame period, the display block driven last in the first sequence is driven first in the second sequence, and an order of each of the other display blocks in the second sequence is higher than that in the first sequence by one

According to another preferred embodiment, a method for driving a display apparatus having a plurality of display blocks is provided. the display blocks are driven in a first sequence during a first frame period. The display blocks are driven in a second sequence during a second frame period immediately following the first frame period, and the first sequence is different from the second sequence.

### BRIEF DESCRIPTION OF THE DRAWINGS

These and other features, aspects and advantages of the present invention will become better understood with regard to the following description, appended claims and accompanying drawings, where:

FIG. 1 shows a conventional liquid crystal display;

FIG. 2 shows a conventional turning-on sequence of each backlight block for several continuous frames;

FIG. 3 is a flowchart of a method for driving a display apparatus according to an embodiment of the present invention;

FIG. 4 shows a turning-on sequence of each backlight block for several continuous frames according to an embodiment of the present invention; and

FIG. 5 shows a system for driving a display apparatus according to an embodiment of the present invention.

### DESCRIPTION OF THE PREFERRED EMBODIMENTS

Reference will now be made in detail to the preferred embodiments of the present invention, examples of which are illustrated in the accompanying drawings. Wherever possible, the same reference numbers are used in the drawings and the description to refer to the same or like parts.

FIG. 3 shows a flowchart 300 of a method for driving a display apparatus according to an embodiment of the present invention. The display apparatus has several display blocks. In step 302, the display blocks are driven in a first sequence during a first frame period. In step 304, the display blocks are driven in a second sequence during a second frame period immediately following the first frame period. The display block driven last in the first sequence is driven first in the second sequence, and an order of each of the other display blocks in the second sequence is higher than that in the first sequence by one.

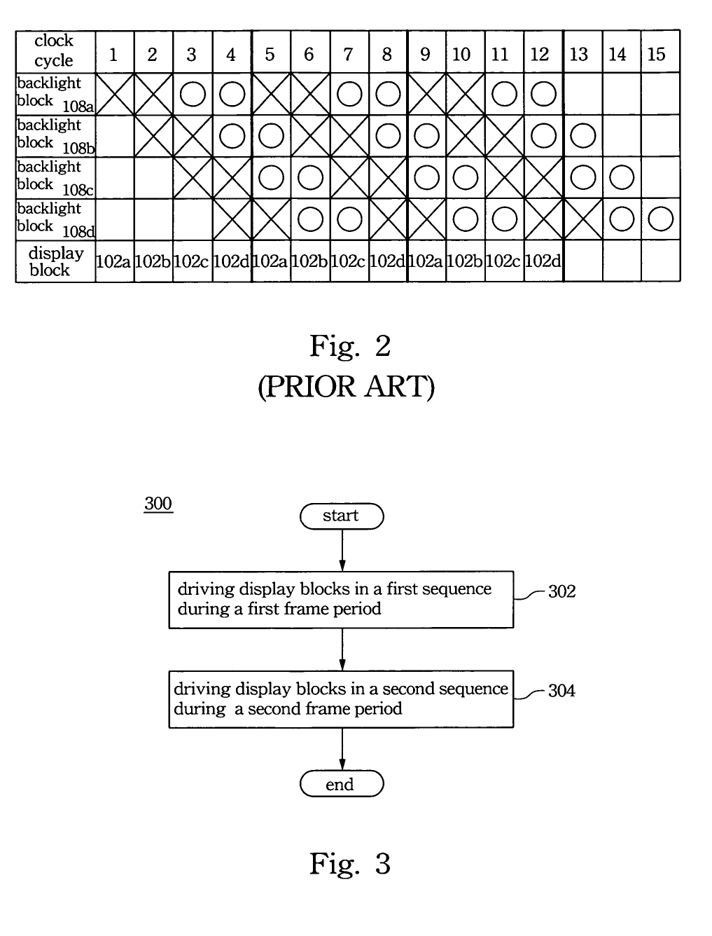

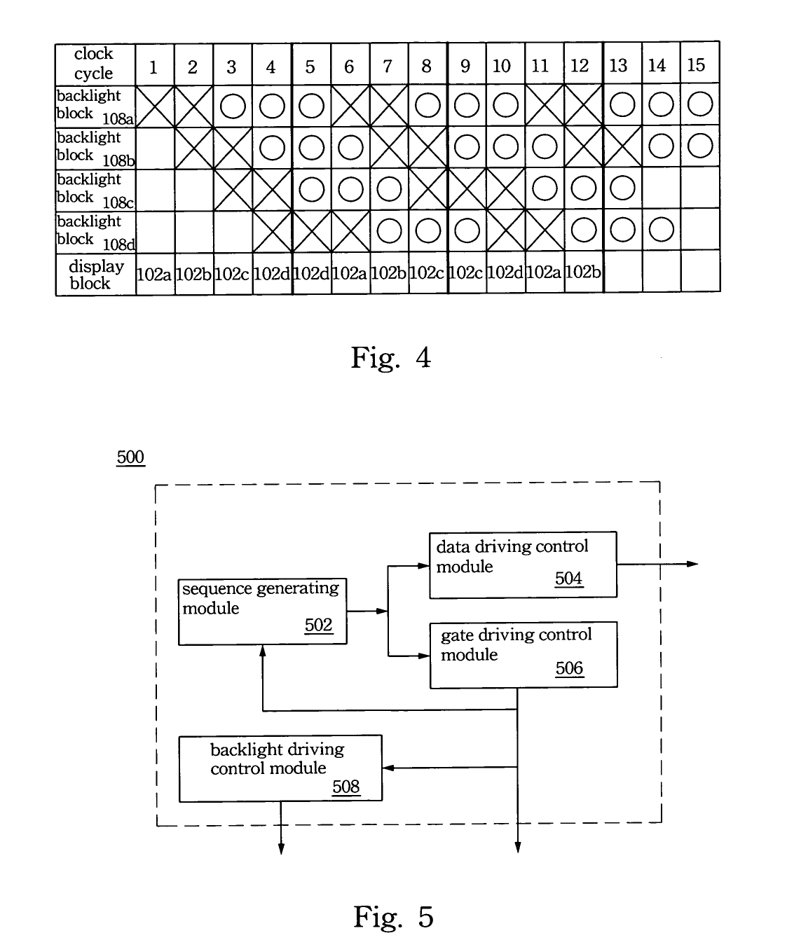

FIG. 4 shows a turning-on sequence of each backlight block for several continuous frames according to an embodiment of the present invention. It is noted that, during the first frame period (clock cycles 1-4), the display blocks are driven in a sequence the same as the conventional turning-on sequence shown in FIG. 2. But in the following second frame period (clock cycles 5-8), the display block 102d driven last (driven in the clock cycle 4) during the first frame period is driven first (driven in the clock cycle 5). Furthermore, the order of each of the other display blocks 102a, 102b and 102c in the sequence for the second frame period is higher than that for the first frame period by one, i.e., the display blocks 102a, 102b and 102c respectively driven first, second and third (respectively driven in the clock cycles 2, 3 and 4) during the first frame period are driven second, third and fourth (respectively driven in the clock cycles 2, 3 and 4) during the second frame period. Similarly, the display block 102c driven last in the second frame period is driven first in the third frame period (the clock cycles 9 to 12) and the order of each of the other display blocks 102d, 102a and 102b in the sequence for the third frame period is higher than that for the second frame period by one, i.e., the display blocks 102d, 102a and 102b respectively driven first, second and third (respectively driven in the clock cycles 5, 6 and 7) during the second frame period are driven second, third and fourth (respectively driven in the clock cycles 10, 11 and 12) during the third frame period.

In this embodiment, the driving sequence of the display blocks changes between any two adjacent frames. The display block driven last during a first frame is driven first in the following second frame, and an order of each of the other display blocks in the driving sequence during the first frame is higher than that during the second frame by one. Accordingly, the turning-on period of each backlight block during the first frame period is not a counterpart of that during the second frame period. For example, during the frame period from the clock cycle to the clock cycle 8, the backlight block 108a is turned on in the clock cycles 5 and 8. However, during the next frame period from the clock cycle 9 to the clock cycle 12, the backlight block 108a is turned on in the clock cycles 9 and 10 which are not counterparts of the clock cycles 5 and 8.

Additionally, the brightness resulting from the previously described turning-on sequence could be higher than that resulting from the conventional backlight control mode. It is noted that, during the first and second frame period (the clock cycles 1 to 8), the backlight block 108a corresponding to the display block 102a is turned on from the beginning of the clock cycle 3 to the end of the clock cycle 5. The backlight block 108a is turned off at the beginning of the clock cycle 6 when the display block 102a is driven for the second frame. Thus, in comparison with the conventional turning-on sequence shown in FIG. 2, the backlight block 102a is turned on for one extra clock cycle. Similarly, the backlight blocks 108b, 108c and 108d are also turned on for three clock cycles.

In the previously described embodiment, the number of the display blocks and the length of the frame period are only exemplary and not limited to 4 and 4 clock cycles.

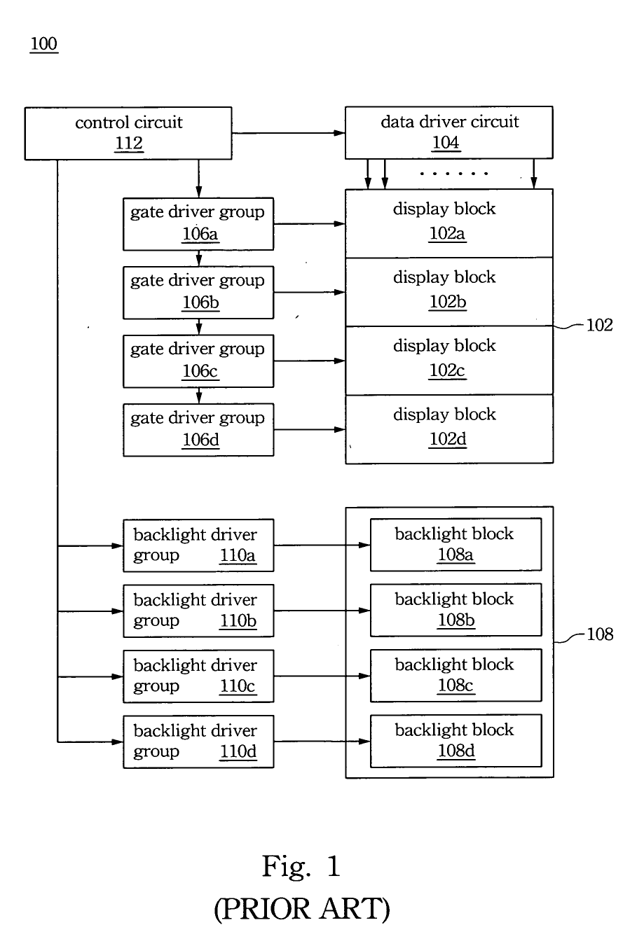

FIG. 5 shows a system 500 for driving a display apparatus according to an embodiment of the present invention. The system 500 implements the method shown in FIG. 3 and may be included in the control circuit 112 shown in FIG. 1. The system 500 includes a sequence generating module 502, a data driving control module 504 and a gate driving control module 506. The sequence generating module 502 determines a driving sequence for each frame. The gate driving control module 506 and the data driving control module 504 control the gate driver groups 106a-106d and the data driver circuit 104 shown in FIG. 1 to scan and drive the display blocks 102a-102d according to the driving sequence for each frame, respectively. The driving sequence determined for a first frame is different from that for a following second frame. The display block driven last in the driving sequence determined for the first frame is driven first in the driving sequence determined for the second frame, and an order of each of the other display blocks in the driving sequence determined for the second frame is higher than that for the first frame by one.

The system 500 further includes a backlight driving control module 508 controlling backlight driver groups 110a-110d to turn on and off the backlight blocks 108a-108d in response to the charging periods of the display blocks 102a-102d. For example, during the frame period from the clock cycles 5-8, the backlight block 108a corresponding to the display block 102a, the charging period of which starts from the beginning of the clock cycle 6 and finishes at the end of the clock cycle 7, is turned on in the clock cycles 5 and 8, and turned off in the clock cycles 6 and 7. Similarly, the backlight blocks 108b, 108c and 108d are turned on and off in response to the charging periods of the display clocks 102b, 102c and 102d.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for driving a display apparatus having a plurality of display blocks, the method comprising the steps of:
driving the display blocks in a first sequence during a first frame period; and
driving the display blocks in a second sequence during a second frame period immediately following the first frame period;
wherein the display block driven last in the first sequence is driven first in the second sequence, and an order of each of the other display blocks in the second sequence is higher than that in the first sequence by one.

2. The method as claimed in claim 1, wherein the display apparatus is a liquid crystal display (LCD).

3. The method as claimed in claim 1, wherein the display apparatus further comprises a backlight module having a plurality of backlight blocks corresponding to the display blocks in position, and each of the backlight blocks is turned on when a charging period of the corresponding display block is finished.

4. A method for controlling a backlight module having at least one backlight block, the method comprising the steps of:
turning on the backlight block during a first turning-on period within a first frame period; and
turning on the backlight block during a second turning-on period within a second frame period immediately following the first frame period;
wherein the first turning-on period within the first frame period is one other than a counterpart of the second turning-on period within the second frame period.

5. The method as claimed in claim 4, wherein the first and second frame periods are divided into a plurality of time sections, and one of the first and second turning-on periods comprises at least two of the time sections.

6. The method as claimed in claim 4, wherein a charging period of a display block corresponding to the backlight block is shorter than the first and second turning-on period.

7. A system for driving a display apparatus having a plurality of display blocks, the system comprising:
a sequence generating module determining a first and second sequence;
a gate driving control module controlling a plurality of gate driver groups of the display apparatus to scan the display blocks according to the first and second sequence; and
a data driving control module controlling a data driver circuit of the display apparatus to drive the display blocks scanned by the gate driver groups,
wherein, the display blocks are driven in the first sequence during a first frame period and driven in the second sequence during a second frame period immediately following the first frame period, the display block driven last in the first sequence is driven first in the second sequence, and an order of each of the other display blocks in the second sequence is higher than that in the first sequence by one.

8. The system as claimed in claim 7, wherein the display apparatus is a liquid crystal display (LCD).

9. The system as claimed in claim 7, wherein the display apparatus further comprises a backlight module having a plurality of backlight blocks each corresponding to one of the display blocks in position.

10. The system as claimed in claim 9, further comprising a backlight driving control module controlling a plurality of backlight driving groups of the display apparatus, each of which turns on and off one of the backlight blocks in response to a charging period of the corresponding display block.

11. The system as claimed in claim 10, wherein each of the backlight blocks is turned on when a charging period of the corresponding display block is finished.

12. A display apparatus, comprising:
a pixel array comprising a plurality of display blocks;
a plurality of gate driver groups scanning the display blocks;
a data driver circuit driving the display blocks scanned by the gate driver groups; and
a control circuit, comprising:
a sequence generating module outputting a first and second sequence;
a gate driving control module controlling a plurality of gate driver groups of the display apparatus to scan the display blocks according to the first and second sequence; and
a data driving control module used to control a data driver circuit to drive the display blocks scanned by the gate driver groups,
wherein, the display blocks are driven in the first sequence during a first frame period and driven in the second sequence during a second frame period immediately following the first frame period, the display block driven last in the first sequence is driven first in the second sequence, and an order of each of the other display blocks in the second sequence is higher than that in the first sequence by one.

13. The display apparatus as claimed in claim 12, wherein the display apparatus is a liquid crystal display (LCD).

14. The display apparatus as claimed in claim 12, further comprising a backlight module has a plurality of backlight blocks each corresponding to one of the display blocks in position.

15. The display apparatus as claimed in claim 14, wherein the control circuit further comprises a backlight driving control module controlling the backlight driving groups to turn on and off one of the backlight blocks in response to a charge period of the corresponding display block.

16. The display apparatus as claimed in claim 15, wherein each of the backlight blocks is turned on when a charging period of the corresponding display block is finished.

17. A method for driving a display apparatus having a plurality of display blocks, the method comprising the steps of:
driving the display blocks in a first sequence during a first frame period; and
driving the display blocks in a second sequence during a second frame period immediately following the first frame period;
wherein the first sequence is different from the second sequence.

18. The method as claimed in claim 17, wherein the display apparatus further comprises a plurality of backlight blocks each corresponding to one of the display blocks in position and the method further comprises the steps of:
turning on the backlight blocks in the first sequence during the first frame period; and
turning on the backlight blocks in the second sequence during the second frame period.
